(19) United States
(12) Patent Application Publication
(10) Pub. No.: US 2012/0190301 A1
(43) Pub. Date: Jul. 26, 2012

(54) MOTION-BASED INTERACTION BETWEEN A PORTABLE ELECTRONIC DEVICE AND A STATIONARY COMPUTING DEVICE

(75) Inventor: Matt Eric Hart, Lunenburg, MA (US)

(73) Assignee: INTUIT INC., Mountain View, CA (US)

(21) Appl. No.: 13/012,092

(22) Filed: Jan. 24, 2011

(51) Int. Cl. H04B 7/00

(52) U.S. Cl. 455/41.2

(57) ABSTRACT

The disclosed embodiments provide a system for interacting with a stationary computing device. During operation, the system detects a proximity of a user of the portable electronic device to a stationary computing device. Next, the system uses the proximity to obtain identity data associated with at least one of the user and the portable electronic device. The system then uses the identity data to establish a connection with the portable electronic device. Finally, the system performs one or more tasks for the user on the stationary computing device based on a set of motion-based commands from the portable electronic device.

### BACKGROUND

### Related Art

The present embodiments relate to techniques for transferring data between electronic devices. More specifically, the present embodiments relate to motion-based interaction between a portable electronic device and a stationary computing device.

Technological advances have steadily increased the feature sets of modern portable electronic devices. For example, a recently released mobile phone may include significant amounts of processing power, memory, and storage; specialized components such as an accelerometer, camera, wireless transceiver, and/or compass; and support for a variety of applications and digital media. Furthermore, the portability and convenience of portable electronic devices may allow users to take advantage of computing-device functionality in day-to-day activities. For example, a user may carry a mobile phone at all times and use the mobile phone to send and receive emails, conduct phone calls, search for directions, browse the Internet, manage tasks and events, and/or view documents and images.

Users of portable electronic devices may also encounter and/or utilize a number of other computing devices in everyday life. For example, a user may store personal information and/or perform complex tasks on a personal computer, access services on a public kiosk, withdraw money from an automated teller machine (ATM), and/or print documents and photos on a printer. However, users who interact with multiple computing devices may have difficulty migrating the functionality and/or data of one device to another device. For example, a user may make a call on a fixed-line telephone by looking up a phone number in his/her mobile phone and manually entering the phone number into the fixed-line telephone instead of transferring the phone number directly to the fixed-line telephone from the mobile phone.

Hence, what is needed is a mechanism for facilitating and/or coordinating interaction between a user and multiple computing devices.

### SUMMARY

The disclosed embodiments provide a system for interacting with a stationary computing device. During operation, the system detects a proximity of a user of the portable electronic device to a stationary computing device. Next, the system uses the proximity to obtain identity data associated with at least one of the user and the portable electronic device. The system then uses the identity data to establish a connection with the portable electronic device. Finally, the system performs one or more tasks for the user on the stationary computing device based on a set of motion-based commands from the portable electronic device.

In some embodiments, the proximity of the user is detected using a radio-frequency identification (RFID) mechanism, a biometric technique, input from the user to the stationary computing device, a broadcast from the portable electronic device, or a location of the portable electronic device.

In some embodiments, the proximity of the user is based on a presence of the user within a predefined area around the stationary computing device and a period of time spent by the user in the predefined area.

In some embodiments, using the identity data to establish the connection with the portable electronic device involves obtaining a device identifier for the portable electronic device from the identity data, and using the device identifier to connect to the portable electronic device.

In some embodiments, each of the tasks is associated with at least one of updating a display on the stationary computing device and transmitting data between the portable electronic device and the stationary computing device.

In some embodiments, the stationary computing device is a computer system, a kiosk, an automated teller machine (ATM), or a fixed-line telephone.

### BRIEF DESCRIPTION OF THE FIGURES

FIG. 1 shows a schematic of a system in accordance with an embodiment.

FIG. 2 shows the interaction between a portable electronic device and a stationary computing device in accordance with an embodiment.

FIG. 3A shows an exemplary set of motions for generating motion-based commands on a portable electronic device in accordance with an embodiment.

FIG. 3B shows an exemplary set of motions for generating motion-based commands on a portable electronic device in accordance with an embodiment.

FIG. 4A shows an exemplary set of motions for generating a motion-based command on a portable electronic device in accordance with an embodiment.

FIG. 4B shows an exemplary motion for generating a motion-based command on a portable electronic device in accordance with an embodiment.

FIG. 5 shows a flowchart illustrating the process of interacting with a portable electronic device in accordance with an embodiment.

FIG. 6 shows a flowchart illustrating the process of interacting with a stationary computing device in accordance with an embodiment.

FIG. 7 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for facilitating interaction with a stationary computing device, such as a kiosk, computer system, automated teller machine (ATM) and/or fixed-line telephone. More specifically, the disclosed embodiments provide a method and system for facilitating interaction between the stationary computing device and a user of a portable electronic device such as a mobile phone and/or tablet computer.

First, potential interaction between the user and the stationary computing device may be detected as a proximity of the user to the stationary computing device. The user's proximity to the stationary computing device may be detected using a radio-frequency identification (RFID) mechanism, a biometric technique, input from the user to the stationary computing device, a broadcast from the portable electronic device, and/or a location of the portable electronic device. The proximity may also be used to obtain identity data that is used to establish a connection with the portable electronic device.

The stationary computing device may then perform one or more tasks based on a set of motion-based commands from the portable electronic device. The motion-based commands may be generated by tracking a motion of the portable electronic device using an accelerometer on the portable electronic device, then analyzing the tracked motion to determine a motion-based command corresponding to the motion. The generated motion-based commands may also be sent from the portable electronic device to the stationary computing device for processing and subsequent execution of the task(s). For example, the motion-based commands may allow the user to update a display on the stationary computing device and/or transmit data between the stationary computing device and the portable electronic device.

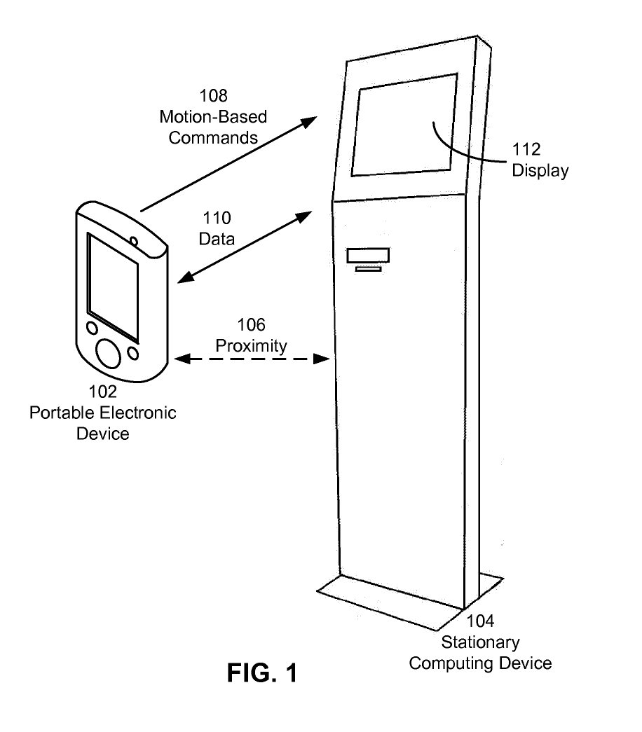

FIG. 1 shows a schematic of a system in accordance with an embodiment. As shown in FIG. 1, the system includes a portable electronic device 102 and a stationary computing device 104. Portable electronic device 102 may correspond to a mobile phone, tablet computer, and/or other portable electronic device with motion-tracking functionality. Stationary computing device 104 may correspond to a computer system, kiosk, automated teller machine (ATM), fixed-line telephone, and/or other fixed computing device.

Those skilled in the art will appreciate that the same user may utilize the functionality of both portable electronic device 102 and stationary computing device 104 to perform everyday tasks. For example, the user may use a mobile phone to make and receive calls, send and receive emails, browse the Internet, and/or maintain a calendar. On the other hand, the user may interact with a kiosk to pay for parking, obtain information about an event, and/or check into a flight.

Furthermore, the user may use a separate interface with each device to interact with the device. However, variations in interface implementations may cause the user to be unfamiliar with one or both interfaces. For example, the user may learn to use the interface of his/her mobile phone or tablet computer over a period of hours, days, and/or weeks. On the other hand, the user may only intermittently interact with a variety of public computer systems and/or kiosks. As a result, the user may have difficulty finding and/or accessing certain features of stationary computing device 104 and/or portable electronic device 102.

Portable electronic device 102 and stationary computing device 104 may also lack a mechanism for communicating directly with one another. In turn, the user may be required to manually transmit data from stationary computing device 104 to portable electronic device 102 to access the data outside of stationary computing device 104. For example, the user may interact with stationary computing device 104 to register and/or sign in for an event. To obtain a schedule for the event, the user may manually type in his/her email address on a touch-screen display 112 of stationary computing device 104 and submit the email address to stationary computing device 104. Stationary computing device 104 may then send the schedule to the user via an email to the email address. Finally, the user may access the schedule by downloading and/or viewing the contents of the email on portable electronic device 102. Consequently, features and/or data associated with one device may be difficult to transfer to and/or use in conjunction with the other device.

In one or more embodiments, the system of FIG. 1 facilitates efficient and/or intuitive user interaction with both portable electronic device 102 and stationary computing device 104 by enabling communication between portable electronic device 102 and stationary computing device 104. First, potential use of stationary computing device 104 by the user may be detected as a proximity 106 of the user and/or portable electronic device 102 to stationary computing device 104. Proximity 106 may be detected using a radio-frequency identification (RFID) mechanism, a biometric technique, input from the user to stationary computing device 104, a broadcast from portable electronic device 102, and/or a location of portable electronic device 102.

Stationary computing device 104 may also use proximity 106 to obtain identity data that is used to establish a connection with portable electronic device 102. For example, stationary computing device 104 may detect proximity 106 as a signal from an RFID tag on the user and/or portable electronic device 102. Stationary computing device 104 may then use the tag identifier from the RFID tag to retrieve an email address for the user and/or a phone number for portable electronic device 102 from a user profile of the user. Finally, stationary computing device 104 may establish a connection with portable electronic device 102 by sending a connection request in the form of an email or text message to portable electronic device 102.

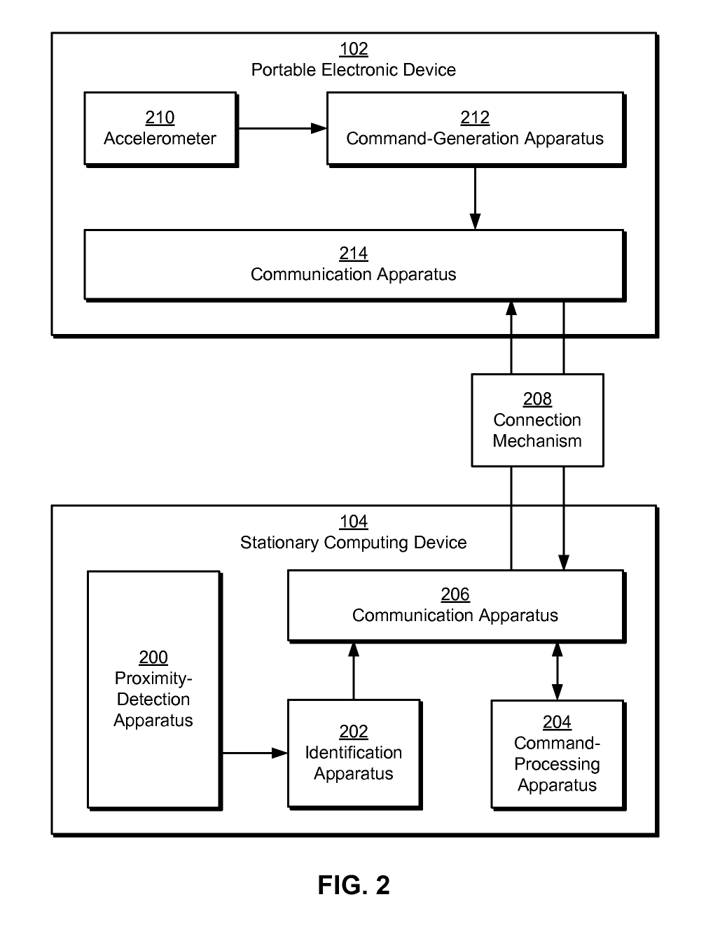

After the connection is established, the user may interact with stationary computing device 104 by generating a set of motion-based commands 108 on portable electronic device 102. The user may specify a motion-based command by moving portable electronic device 102 in a specific direction and/or set of directions. The motion may be tracked by an accelerometer on portable electronic device 102 and analyzed to determine the specific motion-based command represented by the motion. The motion-based command may then be sent to stationary computing device 104 through the connection to allow stationary computing device 104 to perform a task corresponding to the motion-based command. For example, the motion-based command may cause stationary computing device 104 to update display 112 and/or trigger the transmission of data 110 between portable electronic device 102 and stationary computing device 104. Motion-based interaction between portable electronic device 102 and stationary computing device 104 is discussed in further detail below with respect to FIG. 2.

FIG. 2 shows the interaction between portable electronic device 102 and stationary computing device 104 in accordance with an embodiment. Portable electronic device 102 may correspond to a mobile phone, tablet computer, and/or other mobile computing device that may be carried around and used by a user in a number of settings. Conversely, stationary computing device 104 may correspond to a computer system, kiosk, ATM, fixed-line telephone, and/or other fixed electronic system that provides information and/or services to users in the vicinity of stationary computing device 104.

In one or more embodiments, interaction between the user of portable electronic device 102 and stationary computing device 104 may be based on the user's proximity to stationary computing device 104, as detected by a proximity-detection apparatus 200 in stationary computing device 104. Proximity-detection apparatus 200 may utilize a variety of proximity-detection mechanisms to detect the user's proximity to stationary computing device 104. For example, proximity-detection apparatus 200 may use an antenna (e.g., RFID, Bluetooth (Bluetooth™ is a registered trademark of Bluetooth SIG, Inc.)), a biometric (e.g., fingerprint, iris, face) scanner, and/or an input/output (I/O) device (e.g., touch-screen display, keyboard, magnetic card reader) to detect the presence of one or more users and/or portable electronic devices within a predefined area (e.g., radius, distance) around stationary computing device 104.

Alternatively, proximity-detection apparatus 200 may reside on portable electronic device 102 and detect the user's proximity to stationary computing device 104 by comparing the relative locations of the two devices. For example, proximity-detection apparatus 200 may obtain a location for portable electronic device 102 from a Global Positioning System (GPS) receiver and/or wireless transceiver on portable electronic device 102. Proximity-detection apparatus 200 may then compare the location with a list of known locations of kiosks. If the location is within a certain distance of a kiosk's known location, the user is identified as proximate to the kiosk.

Furthermore, proximity-detection apparatus 200 may detect the user's proximity to stationary computing device 104 based on a period of time spent by the user in the predefined area. For example, proximity-detection apparatus 200 may consider a user to be in the proximity of stationary computing device 104 if the user remains within three feet of stationary computing device 104 for a period of five seconds or longer. As a result, proximity-detection apparatus 200 may include functionality to distinguish between users who pass through the predefined area around stationary computing device 104 and users who enter the predefined area to use stationary computing device 104.

The proximity may then be used by an identification apparatus 202 in stationary computing device 104 to obtain identity data associated with the user and/or portable electronic device 102. In particular, identification apparatus 202 may obtain the identity data by scanning the proximity of stationary computing device 104. For example, proximity-detection apparatus 200 may include a camera that monitors an area in front of stationary computing device 104 to detect users approaching stationary computing device 104. Identification apparatus 202 may thus identify the users by applying a facial-recognition technique to faces captured by the camera.

Similarly, proximity-detection apparatus 200 may include an RFID antenna that detects RFID tags within a three-foot radius of stationary computing device 104. Signals from the RFID tags may subsequently be analyzed by identification apparatus 202 to obtain tag identifiers that uniquely identify the users carrying the RFID tags.

On the other hand, the identity data may be actively provided by the user and/or portable electronic device 102 while the user is in the proximity of stationary computing device 104. For example, proximity-detection apparatus 200 may detect the user's proximity after the user initiates use of stationary computing device 104 through one or more I/O devices (e.g., keyboards, touch-screen displays, magnetic card readers, etc.) on stationary computing device 104. In turn, identification apparatus 202 may obtain the identity data as a username entered by the user through the I/O device(s).

Along the same lines, portable electronic device 102 may broadcast a Bluetooth identifier. The Bluetooth identifier may be detected by a Bluetooth antenna associated with proximity-detection apparatus 200 as the user nears stationary computing device 104. The Bluetooth identifier may then be used by identification apparatus 202 to identify portable electronic device 102 and/or the user.

In one or more embodiments, the identity data is used to establish a connection between portable electronic device 102 and stationary computing device 104. First, identification apparatus 202 may obtain a device identifier for portable electronic device 102 from the identity data. The device identifier may correspond to a phone number, hardware identifier, Bluetooth identifier, International Mobile Subscriber Identity (IMSI), and/or other piece of data that uniquely identifies portable electronic device 102. For example, the device identifier may be entered into stationary computing device 104 by the user (e.g., as a phone number) and/or broadcast by portable electronic device 102 (e.g., as a Bluetooth identifier).

Alternatively, identity data for the user may be processed to obtain the device identifier. For example, stationary computing device 104 may identify the user using a tag identifier from the user's RFID tag and/or a username for the user. Identification apparatus 202 may use the tag identifier and/or username to retrieve a user profile for the user from a database and obtain a phone number for portable electronic device 102 from the user profile.

Next, the device identifier and a connection mechanism 208 may be used by a communication apparatus 206 on stationary computing device 104 to establish a connection with portable electronic device 102. Communication apparatus 206 may correspond to a wireless transceiver, network interface card (NIC), port, and/or other component that allows stationary computing device 104 to send and receive data over a network (e.g., local area network (LAN), wide area network (WAN), wireless network, mobile phone network, Bluetooth network, intranet, and/or Internet). In turn, connection mechanism 208 may provide a communications channel for connecting communication apparatus 206 to the network. For example, connection mechanism 208 may include one or more routers, wireless access points (WAPs), mobile phone base stations, servers, and/or repeaters for sending and receiving data between network-connected devices.

To establish the connection with portable electronic device 102, communication apparatus 206 may send a request to connect to portable electronic device 102 through connection mechanism 208. The request may be received by a communication apparatus 214 that connects portable electronic device 102 to the network. Communication apparatus 214 may then use connection information from the request to connect to stationary computing device 104.

For example, communication apparatus 206 may send a text message, email, and/or browser event corresponding to the request through connection mechanism 208 to communication apparatus 214. Communication apparatus 214 may obtain an Internet Protocol (IP) address, Media Access Control (MAC) address, port, and/or other connection information from the request and use the connection information to connect to stationary computing device 104 through connection mechanism 208. Alternatively, communication apparatus 214 may connect directly to communication apparatus 206 using a Bluetooth connection and/or wireless ad hoc network.

As described above, the user's proximity to stationary computing device 104 may be detected by portable electronic device 102 rather than by stationary computing device 104. Along the same lines, portable electronic device 102 may include functionality to initiate a connection with stationary computing device 104. For example, portable electronic device 102 may discover the user's proximity to stationary computing device 104 by obtaining known locations of stationary computing devices from a server and comparing the GPS coordinates of portable electronic device 102 with the known locations. Communication apparatus 214 may then send a request to the server to connect to stationary computing device 104, and the server may establish the connection by forwarding the request to stationary computing device 104 and receiving a response from stationary computing device 104.

Once the connection is established, the user may interact with stationary computing device 104 through portable electronic device 102 by generating a set of motion-based commands on portable electronic device 102. In particular, the user may specify a motion-based command by moving portable electronic device 102 in a specific direction and/or set of directions. An accelerometer 210 on portable electronic device 102 may track the motion of portable electronic device 102, and a command-generation apparatus 212 on portable electronic device 102 may analyze the tracked motion to determine the motion-based command represented by the motion. Communication apparatus 214 may then send the motion-based command to communication apparatus 206, and a command-processing apparatus 204 on stationary computing device 104 may perform one or more tasks for the user based on the motion-based command.

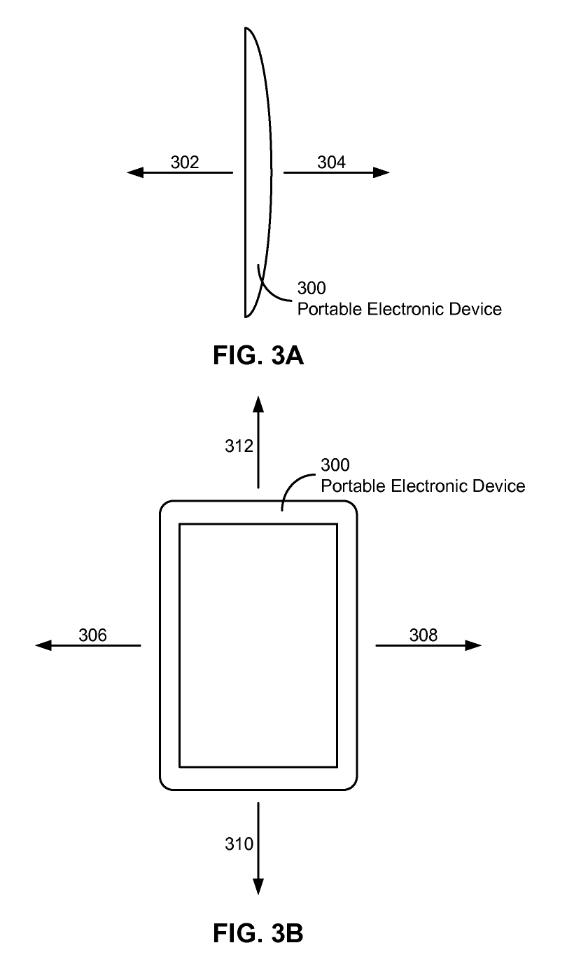

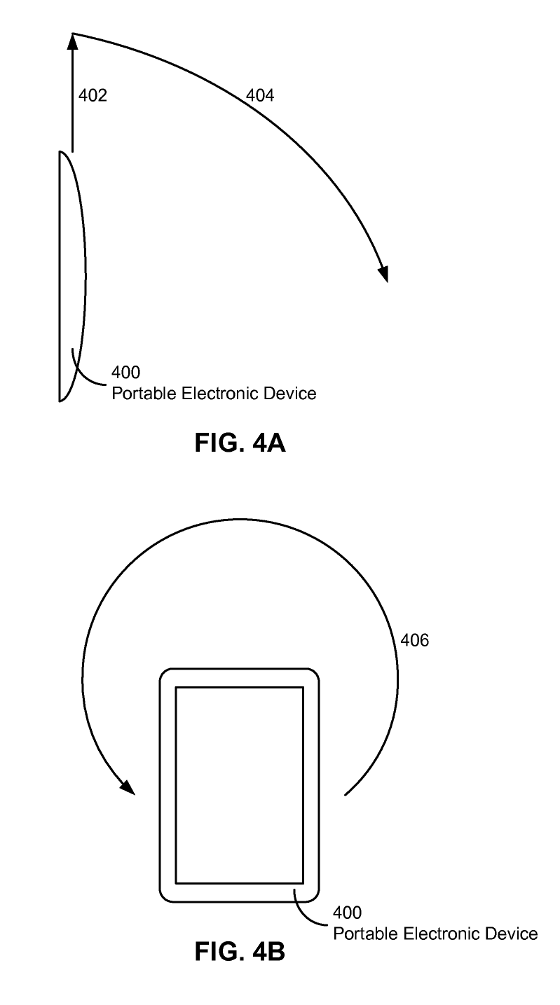

For example, the user may specify a motion-based command to transfer data from stationary computing device 104 to portable electronic device 102 by “pulling” portable electronic device 102 away from stationary computing device 104 with the back of portable electronic device 102 facing stationary computing device 104. The pulling motion may be detected by accelerometer 210 as a negative acceleration in the “z” direction, and command-generation apparatus 212 may map the negative acceleration to a “pull data” command. Communication apparatus 214 may then send the “pull data” command to stationary computing device 104, where command-processing apparatus 204 may execute the command by transmitting data displayed on stationary computing device 104 to portable electronic device 102. Motion-based commands are discussed in further detail below with respect to FIGS. 3A-3B and 4A-4B.

The use of motion-based commands to interact with stationary computing device 104 may thus facilitate the intuitive and/or efficient use of both portable electronic device 102 and stationary computing device 104. In particular, the motion-based commands may allow the user to interact with stationary computing device 104 using functionality found on portable electronic device 102. As a result, the motion-based commands may provide a more intuitive mechanism for interacting with stationary computing device 104 than the interface provided by stationary computing device 104. In addition, the connection between portable electronic device 102 and stationary computing device 104 may allow data to be transferred between the two devices without additional configuration or manual input from the user.

FIG. 3A shows an exemplary set of motions 302-304 for generating motion-based commands on a portable electronic device 300 in accordance with an embodiment. In particular, FIG. 3A shows a view of an upright portable electronic device 300 from the right side. Motion 302 may thus correspond to the “forward” movement of portable electronic device 300, while motion 304 may correspond to the “backward” movement of portable electronic device 300.

Motions 302-304 may be detected by an accelerometer (e.g., accelerometer 210 of FIG. 2) as changes in acceleration in the z-direction. For example, motion 302 may correspond to a negative acceleration in the z-direction, while motion 304 may correspond to a positive acceleration in the z-direction.

To initiate a motion-based command, a user may hold portable electronic device 300 in an upright position with the front of portable electronic device 300 facing him/her. The user may then move portable electronic device 300 toward him/her to perform motion 302, or the user may move portable electronic device 302 away from him/her to perform motion 304. For example, the user may perform motion 302 to transfer data from a stationary computing device to portable electronic device 300 and motion 304 to transfer data from portable electronic device 300 to the stationary computing device.

FIG. 3B shows an exemplary set of motions 306-312 for generating motion-based commands on portable electronic device 300 in accordance with an embodiment. Within FIG. 3B, portable electronic device 300 is shown from the front in an upright position. As a result, motions 306-308 may correspond to sideways movements of portable electronic device 300, while motions 310-312 may correspond to vertical movements of portable electronic device 300.

Motions 306-308 may be detected by the accelerometer as changes in acceleration in the x-direction, while motions 310-312 may be detected as changes in acceleration in the y-direction. For example, motion 306 may correspond to a negative acceleration in the x-direction, and motion 308 may correspond to a positive acceleration in the x-direction. Similarly, motion 310 may correspond to a negative acceleration in the y-direction, and motion 312 may correspond to a positive acceleration in the y-direction.

As with motions 302-304, the user may initiate a motion-based command by holding portable electronic device 300 upright with the front of portable electronic device 300 facing him/her. The user may then move portable electronic device 300 to the left to perform motion 306, to the right to perform motion 308, down to perform motion 310, and up to perform motion 312. For example, the user may perform motions 306-308 to navigate back and forth between different screens on an interface of a stationary computing device. Similarly, the user may perform motions 310-312 to scroll down and up within a screen of the stationary computing device. The user may also “shake” portable electronic device 300 by switching rapidly between motions 306-308 to undo an action on the stationary computing device. As discussed below with respect to FIGS. 4A-4B, other motion-based commands may be specified by combining motions 302-312 in various ways.

FIG. 4A shows an exemplary set of motions 402-404 for generating a motion-based command on a portable electronic device 400 in accordance with an embodiment. Within FIG. 4A, portable electronic device 400 is shown from the right side in an upright position. Portable electronic device 400 is moved upwards during motion 402, then down and backwards during motion 404. As a result, motion 402 may be detected as a positive acceleration in the y-direction, while motion 404 may be detected as a positive acceleration in the z-direction and a negative acceleration in the y-direction.

The user may specify a motion-based command corresponding to motions 402-404 by holding portable electronic device 400 upright for a period, then performing motions 402-404 in sequence without pausing between motions 402-404. For example, motions 402-404 may correspond to an intuitive “basketball throw” and/or “trash toss” movement that allows the user to discard data and/or a previously completed task on a stationary computing device.

FIG. 4B shows an exemplary motion 406 for generating a motion-based command on portable electronic device 400 in accordance with an embodiment. In FIG. 4B, portable electronic device 400 is shown from the front in an upright position. Motion 406 may correspond to a circular motion that is first detected as a positive acceleration in both the x- and y-directions, then as a negative acceleration in the x-direction and a positive acceleration in the y-direction. The second half of motion 406 may be detected as a negative acceleration in both the x- and y-directions, and finally as a positive acceleration in the x-direction and a negative acceleration in the y-direction.

The user may specify a motion-based command corresponding to motion 406 by holding portable electronic device 400 upright and moving portable electronic device 400 in a circle. For example, the user may use motion 406 to generate a motion-based command for selecting a region on a screen of a stationary computing device.

Those skilled in the art will appreciate that other motion-based commands may be generated through detection of acceleration in the x-, y-, and z-directions. For example, a variety of motion-based commands may be specified using motions that rotate and/or flip portable electronic device 400. Similarly, different motion-based commands may be generated by varying the initial orientation of portable electronic device 400 prior to performing one or more motions corresponding to a motion-based command.

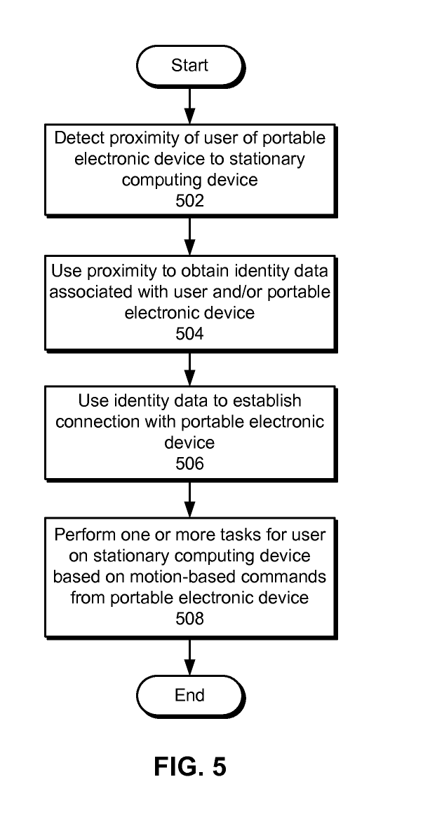

FIG. 5 shows a flowchart illustrating the process of interacting with a portable electronic device in accordance with an embodiment. In one or more embodiments, one or more of the steps may be omitted, repeated, and/or performed in a different order. Accordingly, the specific arrangement of steps shown in FIG. 5 should not be construed as limiting the scope of the embodiments.

First, a proximity of a user of the portable electronic device to a stationary computing device is detected (operation 502). The user's proximity may be detected using an RFID mechanism, a biometric technique, input from the user to the stationary computing device, a broadcast from the portable electronic device, and/or a location of the portable electronic device. Next, the proximity is used to obtain identity data associated with the user and/or portable electronic device (operation 504). For example, biometric data, usernames, Bluetooth identifiers, and/or phone numbers obtained as a result of the user's proximity to the stationary computing device may be used to identify the user and/or portable electronic device.

The identity data may then be used to establish a connection with the portable electronic device (operation 506). For example, a device identifier for the portable electronic device may be obtained from the identity data and used to connect to the portable electronic device. Finally, one or more tasks are performed for the user on the stationary computing device based on a set of motion-based commands from the portable electronic device (operation 508). For example, the stationary computing device may process a motion-based command from the portable electronic device by updating a display, transmitting data to the portable electronic device, and/or obtaining data from the portable electronic device.

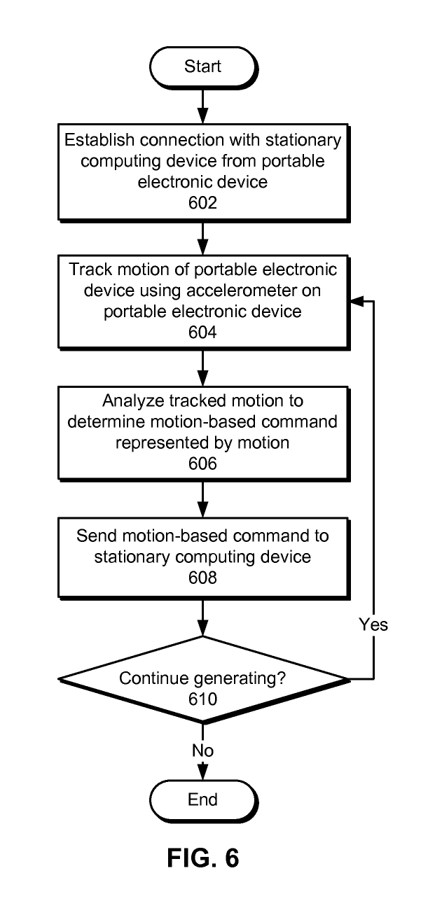

FIG. 6 shows a flowchart illustrating the process of interacting with a stationary computing device in accordance with an embodiment. In one or more embodiments, one or more of the steps may be omitted, repeated, and/or performed in a different order. Accordingly, the specific arrangement of steps shown in FIG. 6 should not be construed as limiting the scope of the embodiments.

Initially, a connection with the stationary computing device is established from a portable electronic device (operation 602). The portable electronic device may establish the connection by receiving a request to connect from the stationary computing device and using connection information from the request to connect to the stationary computing device. Next, a motion-based command is generated by tracking a motion of the portable electronic device using an accelerometer on the portable electronic device (operation 604) and analyzing the tracked motion to determine the motion-based command represented by the motion (operation 606). For example, the motion-based command may involve the detection of a forward motion, backward motion, side-to-side motion, vertical motion, dropping motion, and/or circular motion on the portable electronic device.

The motion-based command is then sent to the stationary computing device (operation 608), where the motion-based command is used to perform one or more tasks for a user of the portable electronic device. For example, the motion-based command may allow the user to interact with the stationary computing device without using the interface provided by the stationary computing device.

Motion-based commands may continue to be generated (operation 610) for the duration of the user's interaction with the stationary computing device. In particular, each motion-based command may be generated by tracking the motion of the portable electronic device (operation 604) and analyzing the tracked motion (operation 606). The motion-based command may then be sent to the stationary computing device (operation 608) to allow the stationary computing device to carry out one or more tasks associated with the motion-based command. Generation and/or transmission of motion-based commands may cease after the user is finished interacting with the stationary computing device.

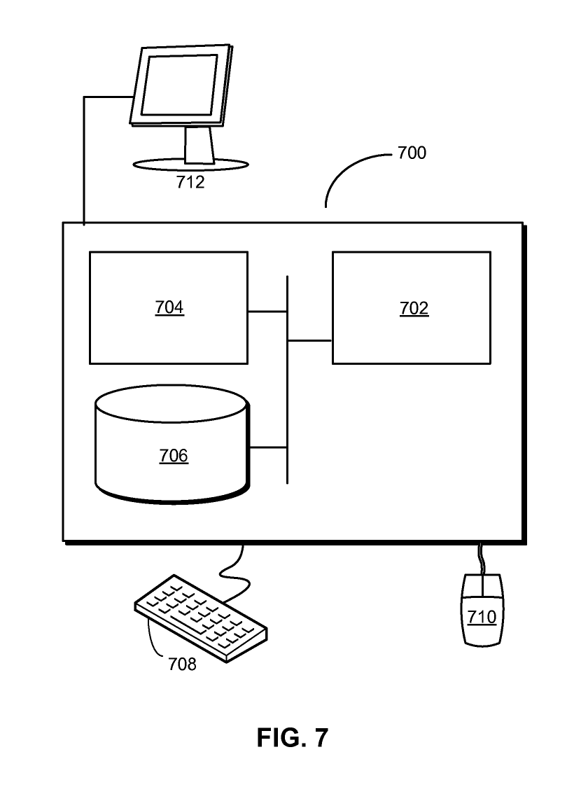

FIG. 7 shows a computer system 700 in accordance with an embodiment. Computer system 700 includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for facilitating interaction between a stationary computing device and a portable electronic device. The system may include a proximity-detection apparatus that detects a proximity of a user of the portable electronic device to a stationary computing device. The system may also include an identification apparatus that uses the proximity to obtain identity data associated with at least one of the user and the portable electronic device, and a communication apparatus that uses the identity data to establish a connection with the portable electronic device. Finally, the system may include a command-processing apparatus that performs one or more tasks for the user on the stationary computing device based on a set of motion-based commands from the portable electronic device.

In addition, one or more components of computer system 700 may be remotely located and connected to the other components over a network. Portions of the present embodiments (e.g., proximity-detection apparatus, identification apparatus, communication apparatus, command-processing apparatus, etc.) may also be located on different nodes of a distributed system that implements the embodiments. For example, the present embodiments may be implemented using a cloud computing system that establishes a connection between the portable electronic device and the stationary computing device and enables the transfer of data and motion-based commands between the portable electronic device and the stationary computing device.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for interacting with a portable electronic device, comprising:
detecting a proximity of a user of the portable electronic device to a stationary computing device;
using the proximity to obtain identity data associated with at least one of the user and the portable electronic device;
using the identity data to establish a connection with the portable electronic device; and
performing one or more tasks for the user on the stationary computing device based on a set of motion-based commands from the portable electronic device.

2. The computer-implemented method of claim 1, wherein the proximity of the user is detected using at least one of:
a radio-frequency identification (RFID) mechanism;
a biometric technique;
input from the user to the stationary computing device;
a broadcast from the portable electronic device; and
a location of the portable electronic device.

3. The computer-implemented method of claim 1, wherein the proximity of the user is based on:
a presence of the user within a predefined area around the stationary computing device; and
a period of time spent by the user in the predefined area.

4. The computer-implemented method of claim 1, wherein using the identity data to establish the connection with the portable electronic device involves:
obtaining a device identifier for the portable electronic device from the identity data; and
using the device identifier to connect to the portable electronic device.

5. The computer-implemented method of claim 1, wherein each of the tasks is associated with at least one of:
updating a display on the stationary computing device; and
transmitting data between the portable electronic device and the stationary computing device.

6. The computer-implemented method of claim 1, wherein the stationary computing device is at least one of a computer system, a kiosk, an automated teller machine (ATM), and a fixed-line telephone.

7. A computer-implemented method for interacting with a stationary computing device, comprising:
establishing a connection with the stationary computing device from a portable electronic device;
generating a set of motion-based commands on the portable electronic device; and
sending the motion-based commands to the stationary computing device, wherein the motion-based commands are used by the stationary computing device to perform one or more tasks for a user of the portable electronic device.

8. The computer-implemented method of claim 7, wherein establishing the connection with the stationary computing device from the portable electronic device involves:
receiving a request to connect from the stationary computing device; and
using connection information from the request to connect to the stationary computing device.

9. The computer-implemented method of claim 7, wherein the connection is established based on:
a proximity of the user to the stationary computing device; and
identity data associated with at least one of the user and the portable electronic device.

10. The computer-implemented method of claim 7, wherein generating the set of motion-based commands on the portable electronic device involves:
tracking a motion of the portable electronic device using an accelerometer on the portable electronic device; and
analyzing the tracked motion to determine a motion-based command represented by the motion.

11. The computer-implemented method of claim 7, wherein each of the motion-based commands is associated with at least one of:
a forward motion;
a backward motion;
a side-to-side motion;
a vertical motion;
a dropping motion; and
a circular motion.

12. The computer-implemented method of claim 7, wherein the portable electronic device is at least one of a mobile phone and a tablet computer.

13. A system for facilitating interaction with a stationary computing device, comprising:
a proximity-detection apparatus configured to detect a proximity of a user of a portable electronic device to the stationary computing device;
an identification apparatus configured to use the proximity to obtain identity data associated with at least one of the user and the portable electronic device;
a communication apparatus configured to use the identity data to establish a connection between the portable electronic device and the stationary computing device; and
a command-processing apparatus configured to perform one or more tasks for the user on the stationary computing device based on a set of motion-based commands from the portable electronic device.

14. The system of claim 13, wherein the proximity of the user is detected using at least one of:
a radio-frequency identification (RFID) mechanism;
a biometric technique;
input from the user to the stationary computing device;
a device identifier for the portable electronic device; and
a location of the portable electronic device.

15. The system of claim 13, wherein the proximity of the user is based on:
a presence of the user within a predefined area around the stationary computing device; and
a period of time spent by the user in the predefined area.

16. The system of claim 13, wherein using the identity data to establish the connection with the portable electronic device involves:
obtaining a device identifier for the portable electronic device from the identity data; and
using the device identifier to connect to the portable electronic device.

17. The system of claim 13, wherein each of the tasks is associated with at least one of:
updating a display on the stationary computing device; and
transmitting data between the portable electronic device and the stationary computing device.

18. The system of claim 13, wherein the portable electronic device is at least one of a mobile phone and a tablet computer.

19. The system of claim 13, wherein the stationary computing device is at least one of a computer system, a kiosk, an automated teller machine (ATM), and a fixed-line telephone.

20. A computer-readable storage medium storing instructions that when executed by a computer cause the computer to perform a method for interacting with a portable electronic device, the method comprising:
detecting a proximity of a user of the portable electronic device to a stationary computing device;
using the proximity to obtain identity data associated with at least one of the user and the portable electronic device;
using the identity data to establish a connection with the portable electronic device; and
performing one or more tasks for the user on the stationary computing device based on a set of motion-based commands from the portable electronic device.

21. The computer-readable storage medium of claim 20, wherein the proximity of the user is detected using at least one of:
a radio-frequency identification (RFID) mechanism;
a biometric technique;
input from the user to the stationary computing device;
a device identifier for the portable electronic device; and
a location of the portable electronic device.

22. The computer-readable storage medium of claim 20, wherein the proximity of the user is based on:
a presence of the user within a predefined area around the stationary computing device; and
a period of time spent by the user in the predefined area.

23. The computer-readable storage medium of claim 20, wherein using the identity data to establish the connection with the portable electronic device involves:
obtaining a device identifier for the portable electronic device from the identity data; and
using the device identifier to connect to the portable electronic device.

24. The computer-readable storage medium of claim 20, wherein each of the tasks is associated with at least one of:
updating a display on the stationary computing device; and
transmitting data between the portable electronic device and the stationary computing device.

25. The computer-readable storage medium of claim 20, wherein the stationary computing device is at least one of a computer system, a kiosk, an automated teller machine (ATM), and a fixed-line telephone.
